(19) United States
(12) Patent Application Publication
(10) Pub. No.: US 2018/0037691 A1
(43) Pub. Date: Feb. 8, 2018

(54) CURABLE COMPOSITIONS AND METHODS OF CATALYZING CHEMICAL REACTIONS

(71) Applicant: PPG INDUSTRIES OHIO, INC., CLEVELAND, OH (US)

(72) Inventors: LAWRENCE JOSEPH FITZGERALD, GIBSONIA, PA (US); BRUCE CONNELLY, GIBSONIA, PA (US); STEVEN R. ZAWACKY, CRANBERRY TOWNSHIP, PA (US); EMMA SHWARTZ, PITTSBURGH, PA (US)

(21) Appl. No.: 15/226,998

(22) Filed: Aug. 3, 2016

(51) Int. Cl. C08G 18/20; C09D 175/06; C08G 18/65; C08G 18/12; C08G 18/73

(52) U.S. Cl. CPC C08G 18/2063; C08G 18/12; C08G 18/73; C08G 18/6511; C09D 175/06

(57) ABSTRACT

Methods of catalyzing chemical reactions are provided. A tertiary amine blocked with an acid, the acid having a vapor pressure greater than 1.0 mm Hg at 25° C., is added as a catalyst to reaction mixtures. Reaction mixtures contain uretdione or isocyanate functional materials, in various combinations with hydroxyl, thiol, and/or amine functional materials. Curable compositions comprising these catalysts and reaction mixtures are also provided.

### STATEMENT REGARDING FEDERALLY SPONSORED RESEARCH OR DEVELOPMENT

This invention was developed with support by the United States Government under agreement number WP2315-SERDP awarded by the Strategic Environmental Research and Development Program (SERDP). The United States Government may have certain rights in the invention.

### FIELD OF THE INVENTION

The present invention is directed to methods of catalyzing chemical reactions and to curable compositions.

### BACKGROUND OF THE INVENTION

Catalysis is a change in the rate of a chemical reaction due to the participation of a material called a catalyst. Catalysts that speed the reaction are called positive catalysts. Catalysts that slow the reaction are called negative catalysts, or inhibitors. Unlike reactants, a catalyst is not consumed by the reaction itself. A catalyst works by providing an alternative reaction pathway to the reaction product. The rate of the reaction is increased when this alternative route has a lower activation energy than the reaction route not mediated by the catalyst. Catalysts can also enable reactions that would otherwise be prevented or slowed by a kinetic barrier. The catalyst may increase reaction rate or selectivity, or enable the reaction at lower temperatures. As such, catalysts can be very valuable tools in industrial processes.

There can be drawbacks to the use of catalysts. For example, tin compounds are used extensively in industrial products such as coatings, as catalysts for isocyanate/hydroxyl reactions. Unfortunately, often the catalyst levels required to provide acceptably fast cure rates and final product properties typically result in a short application time window after the components are mixed. Thus there is a need to work in a timely manner so that the mixed components maintain a low enough viscosity for spraying. The span of time during which the coating is ready to apply to a substrate and still of low enough viscosity to be applied; i.e., the period of time between when the components are mixed to form the curable composition and when the curable composition can no longer be reasonably applied to a surface for its intended purpose is commonly referred to as the working time, or “pot life.” Quantitatively, the time it takes for the viscosity of a composition to double from the initial viscosity is reported as “pot life”.

Typically, pot life must be balanced with cure speed of the applied coating. For instance, in a multi-component coating system that uses a catalyst, the pot life and cure speed are primarily controlled by the amount of catalyst present. Accordingly, if a fast cure speed is required more catalyst can be used but that will also cause a shorter pot life. Conversely, if a longer pot life is needed less catalyst can be used but the cure speed would also be retarded. It is also important that the applied coating composition dry and harden quickly so that dirt pick-up is minimized and valuable shop space isn't occupied with the coated substrate, such as an automobile, while it is drying. The length of time between when a coating is applied to a substrate and when the coating has dried or cured sufficiently that the coated substrate feels dry when lightly touched is referred to as “dry-to-touch time” and is an indicator of the speed of cure. One way to speed the drying and cure of the composition is to add additional catalyst, but this shortens the time available for spraying since higher catalyst levels also cause viscosity of the composition to increase more quickly as reaction rates increase.

Catalysts for uretdione reactions with active hydrogen compounds include amidines, guanidines, diaza-bicycle-undecene, and pyrimidines. Reactions catalyzed by these strong bases can be hard to control and the compositions often have a short pot life. Therefore, it would be desirable to catalyze chemical reactions between uretdiones or isocyanates and active hydrogen functional compounds using catalysts that overcome these drawbacks of the prior art by lengthening the pot life of the composition or by accelerating the reaction rate after application without adversely affecting the pot life. It would be desirable to catalyze chemical reactions using methods and catalysts that overcome the drawbacks of the prior art.

### SUMMARY OF THE INVENTION

In accordance with the present invention, methods of catalyzing chemical reactions are provided. The method includes adding a catalyst to a reaction mixture. The catalyst comprises a tertiary amine blocked with an acid, the acid having a vapor pressure greater than 1.0 mm Hg at 25° C. The reaction mixture comprises:
i) a) a uretdione-functional material and b) at least one of a polythiol, a polyol, and a polyamine; or
ii) a) an isocyanate-functional material and b) at least one of a polythiol, a polyol, and a polyamine.

The present invention also provides a method of increasing the gel time, and hence the pot life, of a reaction mixture. The method includes adding a catalyst to a reaction mixture. The catalyst comprises a tertiary amine blocked with an acid, the add having a vapor pressure greater than 1.0 mm Hg at 25° C. The reaction mixture comprises:
i) a) a uretdione-functional material and at least one of a polythiol, a polyol, and a polyamine; or
ii) an isocyanate-functional material and at least one of a polythiol, a polyol, and a polyamine.

The present invention also provides curable compositions. An exemplary composition comprises:
a) a reaction mixture comprising:
i) a) a uretdione-functional material and b) at least one of a polythiol, a polyol, and a polyamine; or
ii) a) an isocyanate-functional material and b) at least one of a polythiol, a polyamine, and a polyol; and
b) a catalyst comprising a tertiary amine blocked with an acid, wherein the acid has a vapor pressure greater than 1.0 mm Hg at 25° C.

### DETAILED DESCRIPTION OF THE INVENTION

The method of the present invention comprises adding a catalyst to a reaction mixture, forming a curable composition when the reactants are polyfunctional. The catalyst comprises a tertiary amine and may be selected from materials such as amidines, guanidines, diaza-bicyclo-undecene, and pyrimidines. Usually the tertiary amine comprises an amidine, 1,8-diazabicyclo[5.4.0]undec-7-ene, 2,3-dimethyltetrahydropyrimidine, and/or methyl bicycloguanidine. The tertiary amine is reacted with an acid to temporarily hinder or “block” the catalytic activity of the amine functional group. This “blocking” of the amine group allows for a slower reaction rate between the reactants in the reaction mixture and more precise control over the catalyzed reaction. Suitable acids have a vapor pressure greater than 1.0 mm Hg at 25° C. Such adds include, for example, carbonic add and monoacids having one to four carbon atoms, such as formic acid, acetic acid, propionic acid, and isobutyric acid. Mixtures of acids may also be used.

Blocking of the amine may be done by reacting the amine with the add in a suitable reaction medium, such as a solvent. In an exemplary reaction, the amine 1,8-diazabicyclo[5.4.0]undec-7-ene may be dissolved in ethyl acetate and water, and carbon dioxide subsequently bubbled through the solution to form the bicarbonate salt of the amine.

The catalyst is used in an amount sufficient to enable reaction of any reactive functional groups in the reaction mixture. The amount may vary based on the chemistry of the reactants involved, but typically the amount of blocked amine catalyst used in the method of the present invention is 0.1 to 10 percent by weight, often 0.5 to 2 percent by weight, based on the total weight of resin solids in the reaction mixture.

The method of the present invention serves to catalyze a variety of chemical reactions. The reactions may be conducted at a temperature of 50° C. or less, such as 40° C. or less, or 30° C. or less. Often the chemical reaction is conducted at ambient temperature. By “ambient” conditions is meant without the application of heat or other energy; for example, when a curable composition undergoes a thermosetting reaction without baking in an oven, use of forced air, irradiation, or the like to prompt the reaction, the reaction is said to occur under ambient conditions. Usually ambient temperature ranges from 60 to 90° F. (15.6 to 32.2° C.), such as a typical room temperature, 72° F. (22.2° C.).

A number of reaction mixtures are suitable in the method of the present invention. In certain aspects of the present invention, the reaction mixture may comprise i) a) a uretdione-functional material and b) a thiol-, hydroxyl-, and/or amine-functional material; for example, a polythiol, a polyol, and/or a polyamine. The uretdione may be prepared from any isocyanate-functional materials. Most often diisocyanates are used, although other multi-functional isocyanates and monoisocyanates are suitable. Free isocyanate groups that remain may be reacted with, for example, a monoalcohol and/or monoamine, or for the purposes of chain extension, a polyol and/or polyamine. Any isocyanate-functional material described below, including two different isocyanate-functional materials, may be used to prepare the uretdione. In this aspect of the present invention, though not intending to be bound by theory, it is believed that the blocked amine catalyst may first react with the uretdione to form an intermediate in a possible reaction mechanism, and then the intermediate reacts with active hydrogen groups on the other reactant in the reaction mixture (hydroxyl, thiol, and/or amine).

Note that the phrase “and/or” when used in a list is meant to encompass alternative embodiments including each individual component in the list as well as any combination of components. For example, the list “A, B, and/or C” is meant to encompass six separate embodiments that include A, or B, or C, or A+B, or A+C, or B+C, or A+B+C.

Suitable thiol-functional materials for use in the reaction mixture include any material having primary and/or secondary thiol groups. The materials may be monomeric or polymeric, and may be mono- or polyfunctional. As used herein, the terms “polymer” and “polymeric” are meant to refer to prepolymers, oligomers and both homopolymers and copolymers; the prefix “poly” refers to two or more.

Likewise, suitable amine-functional materials for use in the reaction mixture include any monomeric or polymeric material having primary and/or secondary amine groups. Suitable hydroxyl-functional materials for use in the reaction mixture include any monomeric or polymeric material having primary and/or secondary hydroxyl groups, such as monoalcohols, ethylene glycol, propylene glycol, trimethylolpropane, and larger molecules such as polymeric monoalcohols and polyols including acrylic polyols, polyether polyols, polyester polyols, polyurethane polyols, and the like. Combinations of thiol-, hydroxyl-, and amine-functional materials may also be used in the reaction mixture in accordance with the invention.

The reaction mixture may alternatively comprise ii) a) an isocyanate-functional material and b) a thiol-, hydroxyl-, and/or amine-functional material; for example, a polythiol, a polyol, and/or a polyamine. The isocyanate-functional material ii) a) may be any isocyanate-functional material, for example, monoisocyanates, and/or polyisocyanates such as diisocyanates and triisocyanates including biurets and isocyanurates. Biurets of any suitable diisocyanate including 1,4-tetramethylene diisocyanate and 1,6-hexamethylene diisocyanate may be used as reactant ii) a) in the method of the present invention. Also, biurets of cycloaliphatic diisocyanates such as isophorone diisocyanate and 4,4′-methylene-bis-(cyclohexyl isocyanate) can be employed. Examples of suitable aralkyl diisocyanates from which biurets may be prepared are meta-xylylene diisocyanate and α,α,α′,α′-tetramethylmeta-xylylene diisocyanate. The diisocyanates themselves may also be used as reactant ii) a) in the method of the present invention.

Trifunctional isocyanates may also be used as reactant ii) a), for example, trimers of isophorone diisocyanate, trilsocyanato nonane, triphenylmethane triisocyanate, 1,3,5-benzene triisocyanate, 2,4,6-toluene triisocyanate, an adduct of trimethylol propane and tetramethyl xylene diisocyanate sold under the trade name CYTHANE 3160 by CYTEC Industries, and DESMODUR N 3300, which is the isocyanurate of hexamethylene diisocyanate, available from Bayer Corporation. Polyisocyanates often used in curable compositions include cyclic isocyanates, particularly, isocyanurates of diisocyanates such as hexamethylene diisocyanate and isophorone diisocyanate.

The isocyanate-functional material used as reactant ii) a) may also be one of those disclosed above, chain extended with one or more polyamines and/or polyols using suitable materials and techniques known to those skilled in the art.

The present invention is further drawn to a method of increasing the gel time of a reaction mixture comprising adding a catalyst to the reaction mixture. The catalyst and reaction mixture may be any of those described above. The use of the blocked amine catalyst increases both the pot life and gel time of the reaction mixture, such as when the reaction mixture is being prepared at a temperature of 50° C. or less. Often the reaction mixture is prepared and intended for use at ambient temperature, particularly when it is a curable coating composition. Pot life may be quantitatively determined by measuring the viscosity change over time on a CAP 2000 Viscometer with a #1 spindle set at 900 RPM at 25° C. As noted above, the time it takes for the viscosity to double from the initial viscosity is reported as “pot life”. Gel time is related to pot life and refers to the time elapsed after combining all ingredients in bulk in a closed container until the bulk composition does not flow, such as when a dosed vial containing the composition is inverted and the composition does not flow. In the method of the present invention, the gel time of a reaction mixture may be increased to 3.5 hours, or in some cases more than 3.5 hours, when the reaction mixture is held at ambient temperature.

In the methods of the present invention (both catalyzing a chemical reaction and increasing the gel time of a reaction mixture), the catalyst may be added to the reaction mixture simultaneously with or after the components of the reaction mixture have been mixed together. Alternatively, the catalyst may be combined with either or both of the two components before they are combined,

The present invention is also drawn to curable compositions. These curable compositions may be used in any of the methods of the present invention described above. The curable compositions comprise:
a) a reaction mixture comprising:
i) a) a uretdione-functional material and b) a polythiol, a polyol, and/or a polyamine; or
ii) a) an isocyanate-functional material and b) a polythiol, a polyamine, and/or a polyol; and
b) a catalyst comprising a tertiary amine blocked with an add, wherein the add has a vapor pressure greater than 1.0 mm Hg at 25° C. The catalyst and reaction mixture may be any of those described above.

The curable compositions of the present invention may further comprise adjunct ingredients conventionally used in curable compositions such as coating compositions. Optional ingredients such as, for example, plasticizers, surfactants, thixotropic agents, anti-gassing agents, organic cosolvents, flow controllers, anti-oxidants, UV light absorbers, colorants, and similar additives conventional in the art may be included in the composition. These ingredients are typically present at up to about 40% by weight based on the total weight of resin solids in the curable composition.

Typically, the catalyst and reaction mixture are essentially free of epoxy-functional compounds. As used throughout this specification, including the claims, by “essentially free” is meant that if a compound is present in the composition, it is present incidentally in an amount less than 0.1 percent by weight, usually less than trace amounts.

The reaction mixture components may be provided together in a single package. However, it is often not practical to store ambient-cure reaction mixtures as a one-package composition for extended periods of time, but rather they must be stored as multi-package compositions to prevent the components from reacting prior to use. The term “multi-package compositions” refers to compositions such as coatings in which various components are maintained separately until just prior to application. The compositions of the present invention are usually multi-package compositions, such as a two-package coating, wherein the first component a) is a first package and the second component b) is the second package. The catalyst may be a separate, third package and/or combined with either or both of the other two packages. The components of the reaction mixture are typically mixed together immediately prior to the reaction.

The reaction mixture may be a powder or liquid curable composition and may be cast, extruded, rolled, or applied to a substrate as a bead, coating or laminated film. The reaction mixture may also yield a transparent reaction product, suitable for use as a free film, display screen, window (glazing), windshield, lens, and the like.

When the curable composition of the present invention is used as a coating, is may be applied to any appropriate substrate depending on the application. Non-limiting examples of suitable substrates can include, but are not limited to, metal, natural and/or synthetic stone, ceramic, glass, brick, cement, concrete, cinderblock, wood and composites and laminates thereof; wallboard, drywall, sheetrock, cement board, plastic, paper, PVC, roofing materials such as shingles, roofing composites and laminates, and roofing drywall, styrofoam, plastic composites, acrylic composites, ballistic composites, asphalt, fiberglass, soil, gravel and the like. Metals can include aluminum, cold rolled steel, electrogalvanized steel, hot dipped galvanized steel, titanium and alloys; plastics can include but are not limited to TPO, SMC, TPU, polypropylene, polycarbonate, polyethylene, and polyamides (Nylon). The substrates can be primed metal and/or plastic; that is, an organic or inorganic layer is applied thereto.

The coatings may be applied to a substrate as a monocoat or they may be part of a multi-layer coating composite comprising a substrate with various coating layers applied thereto, such as a pretreatment layer, electrocoat, primer, base coat and/or clear coat. At least one of the base coat and clear coat may contain colorant,

As used herein, the term “colorant means any substance that imparts color and/or other opacity and/or other visual effect to the composition. The colorant can be added to the curable composition in any suitable form, such as discrete particles, dispersions, solutions and/or flakes. A single colorant or a mixture of two or more colorants can be used in the curable compositions of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the compositions by grinding or simple mixing. Colorants can be incorporated by grinding into the curable composition by use of a grind vehicle, such as an acrylic grind vehicle, the use of which will be familiar to one skilled in the art,

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinamidone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrole pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as acid dyes, azoic dyes, basic dyes, direct dyes, disperse dyes, reactive dyes, solvent dyes, sulfur dyes, mordant dyes, for example, bismuth vanadate, anthraquinone, perylene, aluminum, quinacridone, thiazole, thiazide, azo, indigoid, nitro, nitroso, oxazine, phthalocyanine, quinoline, stilbene, and triphenyl methane.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticle can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite rnicroparticles” that comprise a nanoparticle and a resin coating on the nanoparticle. Example dispersions of resin-coated nanoparticles and methods for making them are identified in U.S. application Ser. No. 10/876,031 filed Jun. 24, 2004, which is incorporated herein by reference, and U.S. Provisional Application No. 60/482,167 filed Jun. 24, 2003, which is also incorporated herein by reference.

Example special effect compositions that may be used in the curable compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as reflectivity, opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain non-limiting examples, a photosensitive composition and/or photochromic composition, which reversibly alters its color when exposed to one or more light sources, can be used in the composition of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. Ira one non-limiting example, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

The photosensitive composition and/or photochromic composition can be associated with and/or at least partially bound to, such as by covalent bonding, a polymer and/or polymeric materials of a polymerizable component. In contrast to some curable compositions in which the photosensitive composition may migrate out of the composition and crystallize into the substrate, the photosensitive composition and/or photochromic composition associated with and/or at least partially bound to a polymer and/or polymerizable component in accordance with a non-limiting example of the present invention, have minimal migration out of the coating. Exemplary photosensitive compositions and/or photochromic compositions and methods for making them are identified in U.S. application Ser. No. 10/892,919 filed Jul. 16, 2004 and incorporated herein by reference.

In general, the colorant can be present in the curable composition in any amount sufficient to impart the desired property, visual and/or color effect. The colorant may comprise from 1 to 65 weight percent of the present compositions, such as from 3 to 40 weight percent or 5 to 35 weight percent, with weight percent based on the total weight of the compositions.

The coatings can be applied by conventional means including but not limited to brushing, dipping, flow coating, spraying and the like. They are most often applied by spraying. The usual spray techniques and equipment for air spraying, airless spraying, and electrostatic spraying employing manual and/or automatic methods can be used.

Other than in the operating examples, or where otherwise indicated, all numbers expressing quantities of ingredients, reaction conditions and so forth used in the specification and claims are to be understood as being modified in all instances by the term “about,” even if the term does not expressly appear. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Any numerical range recited herein is intended to include all sub ranges subsumed therein. For example, a range of “1 to 10” is intended to include all sub-ranges between and including the recited minimum value of 1 and the recited maximum value of 10, that is, having a minimum value equal to or greater than 1 and a maximum value of equal to or less than 10.

Plural encompasses singular and vice versa; e.g., the singular forms “a” “an,” and “the” include plural referents unless expressly and unequivocally limited to one referent. For example, where the invention has been described in terms of “a” polyisocyanate, a plurality, including a mixture of such compounds, can be used.

Each of the characteristics and examples described above, and combinations thereof, may be said to be encompassed by the present invention. The present invention is thus drawn to the following nonlimiting aspects:

1. A method of catalyzing a chemical reaction comprising adding a catalyst to a reaction mixture, wherein the catalyst comprises a tertiary amine blocked with an acid, the acid having a vapor pressure greater than 1.0 mm Hg at 25° C.; and wherein the reaction mixture comprises:

i) a) a uretdione-functional material and b) a polythiol, a polyol, and/or a polyamine; or

ii) a) an isocyanate-functional material and b) a polythiol, a polyol, and/or a polyamine.

2. The method according to aspect 1, wherein the tertiary amine comprises an amidine, 1,8-diazabicyclo[5.4.0]undec-7-ene, 2,3-dimethyltetrahydropyrimidine, and/or methyl bicyciaguanidine.

3. The method according to any of aspects 1 to 2, wherein the chemical reaction is conducted at a temperature of 50° C. or less.

4. The method according to any of aspects 1 to 3, wherein the tertiary amine is blocked with an add comprising carbonic acid, formic acid, acetic acid, propionic acid, and/or isobutyric acid.

5. The method according to any of aspects 1 to 4, wherein the reaction mixture components are provided in a single package.

6. The method according to any of aspects 1 to 4, wherein the reaction mixture components are provided in separate packages and are mixed together immediately prior to the chemical reaction.

7. A method of increasing the gel time of a reaction mixture comprising adding a catalyst to the reaction mixture, wherein the catalyst comprises a tertiary amine blocked with an acid, the acid having a vapor pressure greater than 1.0 mm Hg at 25° C.; and wherein the reaction mixture comprises:
i) a) a uretdione-functional material and b) a polythiol, a polyol, and/or a polyamine; or
ii) a) an isocyanate-functional material and b) polythiol, a polyol, and/or a polyamine.

8. The method according to aspect 7, wherein the tertiary amine comprises an amidine, 1,8-diazabicyclo[5.4.0]undec-7-ene, 2,3-dimethyltetrahydropyrimidine, and/or methyl bicycloguanidine.

9. The method according to any of aspects 7 to 8, wherein the reaction mixture is prepared at a temperature of 50° C. or less.

10. The method according to any of aspects 7 to 9, wherein the tertiary amine is blocked with an acid comprising carbonic acid, formic acid, acetic acid, propionic acid, and/or isobutyric acid.

11. A curable composition comprising:
a) a reaction mixture comprising:
i) a) a uretdione-functional material and b) a polythiol, a polyol, and/or a polyamine; or)
a) an isocyanate-functional material and b) a polythiol, a polyamine, and/or a polyol; and
b) a catalyst comprising a tertiary amine blocked with an add, wherein the acid has a vapor pressure greater than 1.0 mm Hg at 25° C.

12. The composition according to aspect 11, wherein the tertiary amine comprises an amidine, 1,8-diazabicyclo[5.4.0]undec-7-ene, 2,3-dimethyltetrahydropyrimidine, and/or methyl bicycloguanidine.

13. The composition according to any of aspects 11 to 12, wherein the tertiary amine is blocked with an acid comprising carbonic acid, formic acid, acetic acid, propionic acid, and/or isobutyric acid,

14. The composition according to any of aspects 11 to 13, wherein the reaction mixture components are provided in a single package.

15. The composition according to any of aspects 11 to 13, wherein the reaction mixture components are provided in separate packages and are mixed together immediately prior to use.

The present invention gill further be described by reference to the following examples. The examples are merely illustrative of the invention and are not intended to be limiting. Unless otherwise indicated, all parts are by weight.

### EXAMPLES

### Example 1

### This example demonstrates the preparation of the bicarbonate salt of 1,8-diazabicyclo-(5.4.0)-undec-7-ene (DBU)

A reaction vessel equipped with a condenser, stirrer and thermocouple was placed in an ice bath and blanketed with nitrogen. Eight grams of 1,8-diazabicyclo-(5.4.0)-undec-7-ene (DBU), forty-eight grams of ethyl acetate and one gram of distilled water were added and mixed for five minutes. Carbon dioxide gas was then bubbled through the mixture for thirty minutes. The resulting precipitate was filtered, washed with ethyl acetate and dried under a nitrogen atmosphere,

### Example 2

This example demonstrates the preparation of DBU:bicarbonate salt solution.

To a glass jar equipped with a stir bar was added 5 grams of the salt prepared in Example #1, and 15 grams of butanol. The mixture is stirred for 5 minutes under a CO₂ atmosphere and stored for later use.

### Example 3

This example demonstrates he preparation of a uretdione prepolymer.

A polyuretdione prepolymer was prepared from Desmodur® N 3400 (polyisocyanate having uretdione and isocyanurate groups, prepared from hexamethylene diisocyanate, available from Covestro, Pittsburgh, Pa.), 2-ethyl-1,6-hexanediol, and 2-ethyl-hexanol in an equivalent ratio of 3/2/1 isocyanate/diol/hexanol. The prepolymer was prepared in butyl acetate at 65% weight solids and at 75° C., all isocyanate being consumed by the end of the reaction. The weight average molecular weight (M_{w}) was 21,500, measured using gel permeation chromatography (GPC) with polystyrene standards. In particular, GPC was performed using a Waters 410 differential refractometer (RI detector), Tetrahydofuran (THF) was used as the eluent at a flow rate of 1 ml/min, and two PL Gel Mixed C columns were used for separation. M_{w} of samples was measured relative to linear polystyrene standards of 800 to 900,000.

### Example 4

### Comparative

This example demonstrates the preparation of a DBU catalyzed uretdione coating.

To a glass jar equipped with a stir bar, 7 grams of uretdione prepolymer (Ex. #3), 2.6 grams of an acrylic polyol AROLON 6473 (available from Reichhold LLC), 3.3 grams of methyl ethyl ketone and 0.26 grams of a 25% by weight DEW solution in butyl acetate were added. The sample was mixed for 30 seconds and a portion was drawn down on pre-priced metal panels and allowed to cure at room temperature. The dry film thickness was typically 1.2-1.5 mils. The coated panel was examined initially for dry-to-touch time (coating film feels dry when lightly touched with a finger tip, according to ASTM D5895-13 published Jul. 1, 2013), and after 24 hours at room temperature for solvent resistance (MEK double rubs, according to ASTM D5042-15 published Jun. 1, 2015). The portion of the coating remaining in the jar was capped and examined for gel time (time elapsed after combining all ingredients until the composition does not flow and becomes a non-pourable mass).

### Example 5

This example demonstrates the preparation of a DBU:bicarbonate catalyzed uretdione coating.

In a similar fashion to Comparative Example #4, to a glass jar equipped with a stir bar, 7 grams of uretdione prepolymer (Example #3), 2.6 grams of an acrylic polyol AROLON 6473, 3.3 grams of methyl ethyl ketone and 0.34 grams of the DBU:bicarbonate salt solution of Example #2 were added. The sample was mixed for 30 seconds and a portion was drawn down on pre-primed metal panels and allowed to cure in a similar manner to the procedure used in Comparative Example #4. The coated panel and remaining portion of the coating in the jar were examined in the same way as Example #4.

### Example 6

This example demonstrates the preparation of a propionate:bicarbonate salt of DBU.

To a glass jar equipped with a stir bar, 2.50 grams of DBU, 1.98 grams of n-butyl acetate, 5.25 grams of butanol and 0.49 grams of propionic acid were added and mixed. Carbon dioxide gas was then bubbled through the mixture for 30 minutes. The solution was capped and stored for later use.

### Example 7

This example demonstrates the preparation of a DBU:propionate-bicarbonate catalyzed uretdione coating.

To a glass jar equipped with a stir bar 10 grams of uretdione prepolymer (Example #3), 4.4 grams of acrylic polyol AROLON 6473 and 2.8 grams of n-butyl acetate were added and mixed. Then 0.64 grams of DBU:propionate:bicarbonate salt (Example #6) was added. The sample was mixed for 30 seconds and a portion was drawn down on pre-primed metal panels and allowed to cure in a similar manner to the procedure used in Example #4. The coated panel and the remaining portion of the coating in the jar were examined in the same way as Example #4.

### Example 8

This example demonstrates the preparation of a DBU:isobutyrate salt.

To a glass jar equipped with a stir bar were added 10.0 grams of DBU and 30 grams of butanol. The mixture was stirred for 5 minutes then 5.80 grams of isobutyric acid was added dropwise. Mixing was continued for 10 minutes and the sample was stored for later use.

This example demonstrates the preparation of a DBU:isobutyrate catalyzed uretdione coating.

To a glass jar equipped with a stir bar 7 grams of uretdione prepolymer (Example #3), 2.6 grams of acrylic polyol AROLON 6473 and 3.3 grams of methyl ethyl ketone were added. Then 0.24 grams of DBU:isobutyrate (Example #8) and 0.12 grams of a 25% solution by weight of DBU in butyl acetate were added. The sample was mixed for 30 seconds and a portion was drawn down on pre-primed metal panels and allowed to cure in a similar manner to the procedure described in Example #4. The coated panel and remaining portion of the coating in the jar were examined in the same way as Example #4.

Results of the examination of the coated panels and coatings from Examples #4, #5, #7 & #9 are shown in Table 1 below.

TABLE 1

| | | | | Solvent resis- |
|---|---|---|---|---|
| | | Dry-to-touch | Gel | tance @ 24 |
| | | time | Time | hours (MEK |
| Example | Catalyst | (minutes) | (minutes) | Double rubs) |
| #4 | DBU | 30 | 20 | 100 |
| #5 | DBU:Bicarbonate | 35 | 210 | 100 |
| #7 | DBU:Propionate- | 20 | 105 | 100 |
| | Bicarbonate | | | |
| #9 | DBU:Isobutyrate | 40 | 120 | 100 |

It is apparent from Table 1 that the uretdione-hydroxyl cure is readily catalyzed by DBU (Comparative Example #4) but the gel time is unacceptably short. Reacting DBU with a volatile acid such as carbonic acid or isobutyric acid or with a combination of volatile acids such as propionic and carbonic significantly extends the gel time of the uretdione-hydroxyl cure without interfering with the thy-to-touch time or the solvent resistance after 24 hours of room temperature curing.

### Example 10

This example demonstrates the preparation of the bicarbonate salt of tetrahydro 1,2-dimethylpyrimidene.

To a reaction vessel equipped with a stirrer was added 21 grams of tetrahydro 1,2-dimethylpyrimidene (ADDOCAT 1872, available from Rhein Chemie Additives, a Business Unit of the specialty chemicals Group LANXESS) and 65 grams of butanol. Under agitation, CO₂ gas was passed through the mixture for 2 hours. The resulting solution was transferred to a container, sealed and stored for later use.

### Example 11

This example demonstrates the preparation of the bicarbonate salt of t-butyltetramethyl guanidine.

To a reaction vessel equipped with a stirrer was added 10 grams of t-butyltetramethyl guanidine (TMG) and 43 grams of butanol. Under agitation, CO₂ gas was passed through the mixture for 2 hours. The resulting solution was transferred to a container, sealed and stored for later use.

### Examples 12 to 15

Examples #12 to 15 demonstrate the preparation of coatings catalyzed with unblocked and blocked amines, prepared in a similar manner to previous coating Examples #4, 5, 7 and 9. Examples #12 and 13 are comparative, prepared with unblocked amine catalysts. Ingredients are shown in Table 2.

TABLE 2

| | Comparative | Comparative | Example | Example |
|---|---|---|---|---|
| Material | Example #12 | Example #13 | #14 | #15 |
| Uretdione Pre- | 7.0 | 7.0 | 7.0 | 7.0 |
| polymer (Ex. #3) | | | | |
| Acrylic polyol | 2.6 | 2.6 | 2.6 | 2.6 |
| (AROLON 6473) | | | | |
| Methyl ethyl | 3.3 | 3.3 | 3.3 | 3.3 |
| ketone | | | | |
| ADDOCAT 1872 | 0.10 | — | — | — |
| TMG | — | 0.10 | — | — |
| ADDOCAT 1872 | — | — | 0.30 | — |
| bicarbonate (Ex#8) | | | | |
| TMG bicarbonate | — | — | — | 0.30 |
| (Ex#9) | | | | |

Examples #12 to #15 were drawn down on pre-primed metal panels and allowed to cure in a similar manner to Example #4. The coated panel and remaining portion of the coating in the jar were examined in the same way as Example #4. Results for the evaluation of cure behavior and gel time for Examples #12-#15 are shown in Table 3.

TABLE 3

| | | | | Solvent resis- |
|---|---|---|---|---|
| | | Dry-to-Touch | Gel | tance @ 24 |
| | | time | Time | hours (MEK |
| Example | Catalyst | (Min.) | (Min.) | Double rubs) |
| #12 | ADDOCAT | 13 | 10 | 85 |
| (Comparative) | 1872 | | | |
| #13 | TMG | 1 | 1 | 66 |
| (Comparative) | | | | |
| #14 | ADDOCAT | 25 | 90 | 100 |
| | 1872 | | | |
| | bicarbonate | | | |
| #15 | TMG | 35 | 150 | 78 |
| | bicarbonate | | | |

It is apparent from Table 3 that amidine bases other than DBU will catalyze the uretdione-hydroxyl cure with a similar short gel time. However, reacting the amines with a volatile acid significantly improves gel time of uretdione-hydroxyl cure while maintaining an acceptable dry-to-touch time and solvent resistance at 24 hours.

Whereas particular examples of this invention have been described above for purposes of illustration, it will be evident to those skilled in the art that numerous variations of the details of the present invention may be made without departing from the invention as defined in the appended claims.

1. A method of catalyzing a chemical reaction comprising adding a catalyst to a reaction mixture, wherein the catalyst comprises a tertiary amine blocked with carbonic acid, and wherein the reaction mixture comprises:
i) a) a uretdione-functional material and b) a polythiol, a polyol, and/or a polyamine; or
ii) a) an isocyanate-functional material and b) a polythiol, a polyol, and/or a polyamine.

2. The method of claim 1, wherein the tertiary amine comprises an amidine, 1,8-diazabicyclo[5.4.0]undec-7-ene, 2,3-dimethyltetrahydropyrimidine, and/or methyl bicycloguanidine.

3. The method of claim 1, wherein the chemical reaction is conducted at a temperature of 50° C. or less.

4. (canceled)

5. The method of claim 1, wherein the reaction mixture components are provided in a single package.

6. The method of claim 1, wherein the reaction mixture components are provided in separate packages and are mixed together immediately prior to the chemical reaction.

7. A method of increasing the gel time of a reaction mixture comprising adding a catalyst to the reaction mixture, wherein the catalyst comprises a tertiary amine blocked with carbonic acid, and wherein the reaction mixture comprises:
i) a) a uretdione-functional material and b) a polythiol, a polyol, and/or a polyamine; or
ii) a) an isocyanate-functional material and b) a polythiol, a polyol, and/or a polyamine.

8. The method of claim 7, wherein the tertiary amine comprises an amidine, 1,8-diazabicyclo[5.4.0]undec-7-ene, 2,3-dimethyltetrahydropyrimidine, and/or methyl bicycloguanidine.

9. (canceled)

10. A curable composition comprising:
a) a reaction mixture comprising:
i) a) a uretdione-functional material and b) a polythiol, a polyol, and/or a polyamine; or
ii) a) an isocyanate-functional material and b) a polythiol, a polyamine, and/or a polyol; and
b) a catalyst comprising a tertiary amine blocked with carbonic acid.

11. The composition of claim 10, wherein the tertiary amine comprises an amidine, 1,8-diazabicyclo[5.4.0]undec-7-ene, 2,3-dimethyltetrahydropyrimidine, and/or methyl bicycloguanidine.

12. (canceled)
